(19) United States
(12) Patent Application Publication
(10) Pub. No.: US 2026/0290726 A1
(43) Pub. Date: Sep. 24, 2026

(54) SHAPE OF INSULATOR MEMBER OF VACUUM ENVELOPE OF VACUUM INTERRUPTER, AND SWITCHGEAR EMPLOYING SAME

(71) Applicant: Wangpei Li, Pittsburgh, PA (US)

(72) Inventor: Wangpei Li, Pittsburgh, PA (US)

(21) Appl. No.: 19/083,592

(22) Filed: Mar. 19, 2025

(51) Int. Cl. H01H 33/662

(52) U.S. Cl. CPC H01H 33/66207

(57) ABSTRACT

A thick wall tubular insulator is provided for vacuum envelope construction of a vacuum interrupter. The opening at one end is larger than at the other, to allow for a shortened vacuum envelope and hence shortened electrodes. An outward radial protrusion on its OD wall is provided as a barrier to external flashover, and to allow coverage of the external triple junction at its end with insulative sealant such as a conformal coating and additional insulative protection such as a heat-shrink sleeve or electrical tape. An inward radial protrusion on its ID wall is provided to reduce dielectric degradation from metal vapor deposition. A longitudinal recess on its ID wall is provided to hide the high electrical-field tip of a metal shield to minimize likelihood of internal breakdown to nearby metal components. A GIS, dead-tank breaker, live-tank breaker, recloser, or fault interrupter employing such a vacuum interrupter is also provided.

### BACKGROUND

### 1. Field

The disclosed concept relates to vacuum switching apparatus and, in particular, vacuum switching apparatus such as, for example, vacuum interrupters. The disclosed concept also relates to the vacuum envelope and its insulator members, of a vacuum interrupter, and switchgear employing such a vacuum interrupter, such as gas-insulated switchgear, dead-tank vacuum circuit breakers, live-tank vacuum circuit breakers, generator circuit breakers, reclosers and fault interrupters.

### 2. Background Information

High voltage (HV) vacuum interruption has been the frontier of vacuum switching technology in the last 20 years (see e.g. U.S. Pat. No. 6,891,122, and E. Taylor “Environmentally friendly high-voltage switching technology: vacuum circuit breakers,” Chapter 3 in Green HV Switching Technology for Modern Power Networks, by K. Niayesh, IET 2023). There are, however, several challenges yet to overcome. Chief among them is the dielectric design to meet the high voltage requirements (see e.g. T. Heinz et al, “Why vacuum technology is not a simple scaling from medium to high voltage?”, 30^{th} ISDEIV, June 2023, Okinawa, Japan.) As an example for illustration, FIG. 1 shows a very typical HV vacuum interrupter rated for 66 kV or above, placed inside a surrounding tank. Internally inside the arc chamber of the vacuum interrupter, all the gaps between components of different electrical potentials have to be able to withstand the lighting impulse voltage test without breakdown. Externally the insulating members of the vacuum envelope have to not flashover from the high voltage end to the grounded end, jumping via any exposed metal parts such as an external center shield or a flange or simply the metallization layers, in between the two ends. If the tank is grounded, as in the case of a gas-insulated-switchgear (GIS) or a dead-tank (DT) circuit breaker, the dielectric stresses become much worse, as the zero-volt tank significantly depresses the potential of a nearby electrically floating component, such as the center shield 111 in FIG. 1, leading to large asymmetry in the voltage distribution. Depending on how close the vacuum interrupter is to the tank (and there are tremendous motivations, both technical and financial, for the tank to be small!), the center shield will float to a potential as low as ⅓ of the test voltage applied across an open contact gap. This means the voltage across the center shield to the high voltage end of the vacuum interrupter will be ⅔ of the full test voltage applied across the contact gap. Internally this means that the floating components have to be of a large clearance away from the high voltage end components, or the dielectric withstand capability of the gaps between them must be improved somehow, e.g. with extensive conditioning. Externally the insulators between the high voltage end and the floating center shield have to be able to withstand this same ⅔ of the full test voltage applied. This is an enormous dielectric stress for the insulators, and flashover will happen if the external dielectric withstand capability of the vacuum envelope is not properly designed for (see e.g. W. Li et al, “Measuring external dielectric strength of the vacuum interrupter envelope,” 28^{th} ISDEIV, Greifswald, Germany, September 2018; and W. Li et al, “External dielectric performance of various vacuum interrupter envelope constructions,” 5^{th} ICEPE-ST, Kitakyushu, Japan, October 2019.)

A key characteristic of the envelope design as shown in FIG. 1 is that the insulators 103m, 103f, 105m and 105f are thin straight wall cylinders, with uniform OD (outside diameter) and ID (inside diameter). The first shortcoming of such a design is that, since the external dielectric strength per unit height of a straight wall insulator is limited, the height of the insulator stack (dimension D189) has to be large enough. And to have enough clearance from the coils and contacts, the height of the floating external center shield, commonly and herein referred to as the bellyband, dimension D185, has to be at least that of dimension D187. High values for both dimension D189 and dimension D185 mean the total height of the vacuum envelope (dimension D191) is very high. A tall vacuum interrupter necessitates long electrodes. This is not good for the continuous current-carrying capability of the vacuum interrupter. A very long and hence heavy movable electrode also makes it difficult to achieve the so-called fast-slow-fast optimum opening trajectory of the movable contact, for high current interruption performance.

The second shortcoming of a straight wall insulator design of FIG. 1 is that dimensions D181 and D183 are counteractively linked; they cannot both be increased within any given tank size design constraint, as they are on the opposite sides of a straight wall. This greatly limits the ability to simultaneously improve dielectric performance both inside and outside the vacuum interrupter.

There is, therefore, room for improvement in the design of a HV vacuum interrupter.

### SUMMARY

The overarching idea of the disclosed concept is to bring a second dimension, the radius or wall thickness of the insulator, into the design considerations of a HV vacuum interrupter.

As an aspect of this teaching, a generally tubular insulator with non-uniform ID and OD is provided. Insulators of such can be found in U.S. Pat. Nos. 4,757,166 and 5,510,592, for a medium voltage (MV) vacuum interrupter and for different reasons than what is being discussed here. It has not been applied to an insulator that is joined to a bellyband, which is typical of a HV vacuum interrupter. By the insulator having a larger ID at its end joined to the bellyband than at the opposite end, both of the above-mentioned shortcomings can be addressed. As can be seen in FIG. 2, dimension D285 of the bellyband is now shorter than dimension D287, and the counteracting link between dimensions D281 and D283 is alleviated (to a degree limited by the manufacturability of a thick-wall insulator.) Additionally, such an envelope with a straight wall bellyband makes it much easier for the entire bellyband and its two triple junctions to be covered up tightly with a protective means such as a heat-shrink tubing or a rubber boot, or a molded polyurethane or silicone potting.

As another aspect of this teaching, a radial barrier protrusion, of a significant width in the radial direction, outwardly on the OD wall of the insulator, is introduced to increase the flashover resistance per unit height (dimension D289 in FIG. 2) of the insulator stack, that is, to overcome the first part of the first shortcoming mentioned above. Such a radial barrier protrusion toward the end of the insulator cylinder also allows the triple junction associated with a floating shield flange (e.g. 245m in FIG. 2) to be very well hidden, covered, and protected, thereby preventing it from becoming a steppingstone for flashover, thus improving the external dielectric strength in an envelope design involving multiple insulator cylinders stacked together.

As yet another aspect of the disclosed concept, an insulator with a longitudinal hideout recess on its ID wall is provided, to hide the high electric-field tip of a shield part, such as end-curl 241m in FIG. 2, thereby improving the withstand capability per unit width of the clearance between the floating components and the high voltage end components inside the arc chamber.

As a further aspect of the disclosed concept, a radial barrier protrusion on the ID wall of the insulator inwardly toward its longitudinal axis, is introduced to better protect it against dielectric degradation due to deposit of metal vapor from arcing activities, thereby extending the electrical life of the vacuum interrupter.

Combined together, these aspects of the disclosed concept, or overarchingly the above-mentioned idea to make use of the radius or wall thickness dimension of the insulator, enables a HV vacuum interrupter design that is short and nimble to operate, achieving a comprehensive package of outstanding performance in dielectric withstand, high current interruption, continuous current-carrying, and electrical life. The barrier protrusions and the OD and ID variation from end to end of the insulator can be of various geometrical profiles as well as different combinations between them, in conjunction with variation in the number of insulator members, to suit different particular design options targeting different voltage and fault interruption current ratings, as will be further exemplified in the following.

As another aspect of the disclosed concept, vacuum switching apparatus, such as but not limited to, gas-insulated switchgear, dead-tank vacuum circuit breakers, live-tank vacuum circuit breakers, generator circuit breakers, reclosers and fault interrupters, employing one such vacuum interrupter comprising one or multiple of the disclosed insulators as a member of its vacuum envelope, is also provided.

### BRIEF DESCRIPTION OF THE DRAWINGS

A full understanding of the disclosed concept can be gained from the following description of the preferred embodiments when read in conjunction with the accompanying drawings in which:

FIG. 1 is a sectional view of a vacuum interrupter in accordance with the prior art, wherein the portion to the left of the vertical axis shows the closed position and the portion to the right of the vertical axis shows the open position;

FIG. 2 is a sectional view of a vacuum interrupter, of a first embodiment in accordance with the disclosed concept, employing a top insulator of a frustoconical shape and with two OD barrier protrusions, and a middle insulator with a step-down in OD and ID;

FIG. 2A is an enlarged sectional view of a portion of FIG. 2 showing an OD barrier protrusion;

FIG. 2B is an enlarged sectional view of a portion of FIG. 2 showing triple junction protection means enabled by two butting OD barrier protrusions;

FIG. 2C is an enlarged sectional view of a portion of FIG. 2 showing a longitudinal recess on the ID wall to hide the tip of an end-curl;

FIG. 3 is a half isometric half sectional view of a vacuum interrupter, of a second embodiment in accordance with the disclosed concept, with three insulators stacked together on each side of the bellyband;

FIG. 4 is a sectional view of a vacuum interrupter, of a third embodiment in accordance with the disclosed concept, with the top and bottom insulators having a uniform ID and the middle insulators having gradual change in OD and ID;

FIG. 5 is a sectional view of a vacuum interrupter of a fourth embodiment, with one single insulator on either side of the bellyband, each insulator having multiple features in accordance with the disclosed concept;

FIG. 6 is a sectional view of a vacuum interrupter, of a fifth embodiment in accordance with the disclosed concept, with the OD variation of the insulator being in a sharp zig-zag fashion, and a shield hideout recess of a triangular shape thus formed in the insulator ID wall;

FIG. 7 is a sectional view of a vacuum interrupter, of a sixth embodiment in accordance with the disclosed concept, with barrier protrusions having one-sided shoulder;

FIG. 8 is a sectional view of a vacuum interrupter, of a seventh embodiment in accordance with the disclosed concept, with the design in the insulator and the floating shield end-curl asymmetric between the two sides of the bellyband;

FIG. 9 is a sectional view of a vacuum interrupter, of an eighth embodiment in accordance with the disclosed concept, with a floating internal center shield inside two long insulators each having both OD and ID barrier protrusions as well as a shield hideout recess;

FIG. 10 is a sectional view of a medium voltage vacuum interrupter, of a nineth embodiment in accordance with the disclosed concept, with a floating internal center shield assembly inside two insulator cylinders each having a shield hideout recess; and

FIG. 11 is a sectional view of a medium or low voltage vacuum interrupter, of a tenth embodiment in accordance with the disclosed concept, with a fixed shield, the tip of which is hidden inside a shield hideout recess in the insulator.

All sectional views herein are taken across a diameter and along the longitudinal central axis of the generally tubular vacuum interrupter.

### DESCRIPTION OF THE PREFERRED EMBODIMENTS

As employed herein, the singular forms “a,” “an,” and “the” include plural references unless the context clearly dictates otherwise. Unless defined otherwise, all technical and scientific terms used in this document have the same meanings as commonly understood by one of ordinary skill in the art. As employed herein, the term “comprising” (or “comprises”) means “including (or includes), but not limited to.”

In this document, when terms such as “first” and “second” are used to modify a noun, such use is simply intended to distinguish one item from another, and is not intended to require a sequential order unless specifically stated.

As employed herein, terms such as “top” and “bottom,” “upper” and “lower,” or “front” and “back,” are not intended to have absolute orientations but are instead intended to describe relative positions of various components with respect to each other.

As employed herein, the term “vacuum envelope” means an envelope employing a partial vacuum therein. As employed herein, the term “partial vacuum” means a space (e.g. within a vacuum envelope) partially exhausted (e.g. to the highest degree practicable; to a relatively high degree; to a degree suitable for use in a vacuum switching apparatus application) by a suitable mechanism (e.g. without limitation, a vacuum furnace).

The disclosed concept is described in association with vacuum interrupters, although the disclosed concept is applicable to a wide range of vacuum switching apparatus. Non-limiting applications for vacuum switching apparatus include a live-tank (LT) circuit breaker, a dead-tank (DT) circuit breaker, a gas insulated switchgear (GIS), a compact/cubicle gas insulated switchgear (C-GIS), a generator circuit breaker, a vacuum circuit breaker (VCB), a recloser, a fault interrupter, a load break switch (LBS), a high voltage (HV) switching apparatus, and a vacuum electrical switching apparatus, for an alternate current (AC) or a direct current (DC) power system.

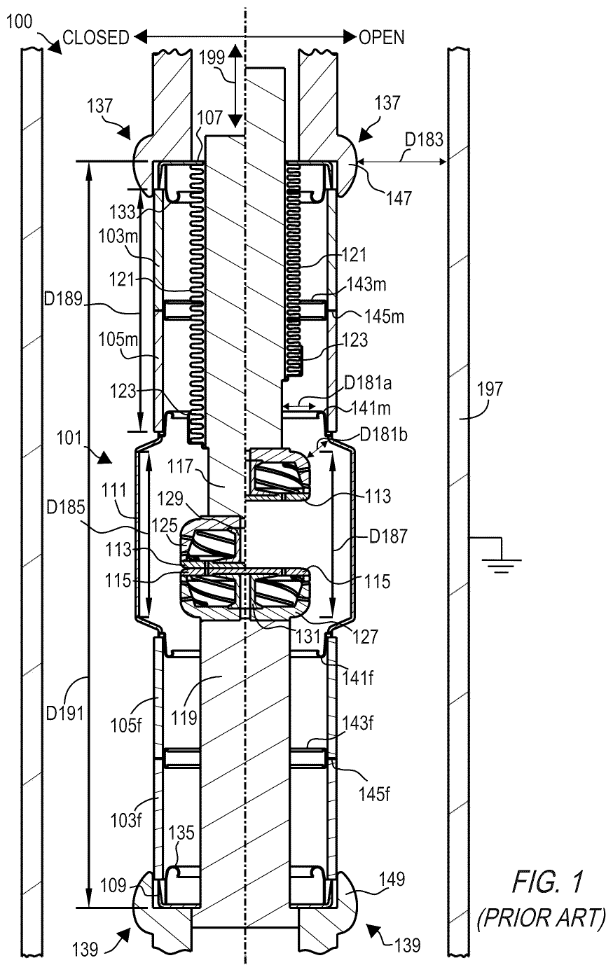

As mentioned in the beginning, FIG. 1 shows a typical HV vacuum interrupter 100 in accordance with the prior art. It includes a vacuum envelope 101 comprising four generally tubular insulator members 103m, 103f, 105m and 105f caped with two metal end-caps 107 and 109. Also part of the vacuum envelope is an electrically floating center shield 111, commonly and herein referred to as the bellyband, that surrounds a pair of separable contacts, the movable contact 113 and the fixed contact 115. The bellyband serves to collect metal vapors and spatters generated in the arcing contact gap in between contacts 113 and 115. Two electrodes 117 and 119 connect the contacts to the busbars (not shown) of the external electrical power line a switchgear employing the vacuum interrupter is protecting. The movable electrode 117 also connects the movable contact 113 to an external driving mechanism (not shown) to move it in the direction of the arrow 199 between a closed position (left side of the vertical axis of FIG. 1) in electrical contact with the fixed contact 115, and an open position (right side of the vertical axis of FIG. 1) spaced apart from the fixed contact 115. A bellows 121 facilitates the transfer of this motion from the exterior to the interior of vacuum envelope 101. A bellows shield 123 protects the thin-walled bellows from any molten spatter originating from arcing activities in between the opening contacts. The exemplary vacuum interrupter shown in FIG. 1 is the axial magnetic field (AMF) type, employing two AMF generating coils 125 and 127 in between the contact and the electrode for the movable end and the fixed end respectively. Two pillar pieces 129 and 131 inside the coils provide mechanical support to the bottom (non-arcing) side of the thin contacts. Often there are also the end-shields 133 and 135 that protect the triple junctions of the metal-to-insulator joints (see more later). Commonly in the field the metal parts are grouped into two ends, the movable end 137 and the fixed end 139, separated by the insulator members 103m, 103f, 105m, and 105f. Movable end 137 (the upper or top end in FIG. 1) includes the electrically connected parts 107, 113, 117, 121, 123, 125, 129, and 133, all holding one first electrical voltage/potential. Fixed end 139 (the lower or bottom end in FIG. 1) includes the electrically connected parts 109, 115, 119, 127, 131, and 135, all holding a same second electrical voltage/potential, when the vacuum interrupter is in the open position.

The generally tubular insulator members 103m, 103f, 105m, and 105f of the vacuum envelope define a common longitudinal axis, the vertical axis of FIG. 1, for vacuum interrupter 100.

A critical concept to both vacuum dielectric and gas dielectric is the triple junction, of the metal-insulator-vacuum junction on the interior of the vacuum envelope, or the metal-insulator-gas junction on the exterior of the vacuum envelope. It is commonly understood that a triple junction is the main source of the starting electrons that eventually lead to a flashover across an insulator, in vacuum or in a gas. For that reason two end-curls 141m and 141f, each going around the corner of the joint and inside the ID wall of insulator 105m and 105f, respectively, are provided to protect the internal triple junctions associated with bellyband 111.

The exemplary envelope design as shown in FIG. 1 uses two stacked-together insulator members (103 and 105) on each side of bellyband 111. If these insulator members are of a glass material, they are joined hermetically sealingly via a Kovar metal piece (or pieces). If these insulator members are of a ceramic material such as alumina, they are hermetically sealingly joined together via a metallization layer (of Mo-Mn topped with Ni) at the ends of their generally tubular shape. Either way metal is involved in the joint, so associated triple junctions need to be protected. This is the reason for the presence of the floating shields 143m and 143f in FIG. 1, to protect the vacuum side triple junctions. These floating shields are secured to the insulators via a flange, 145m and 145f respectively, that is sandwiched in between, and hermetically searlingly joined with, the insulators. (The thin wall flanges, as well as the metallization layers at the ends of a metallized ceramic, are considered members of the vacuum envelope.)

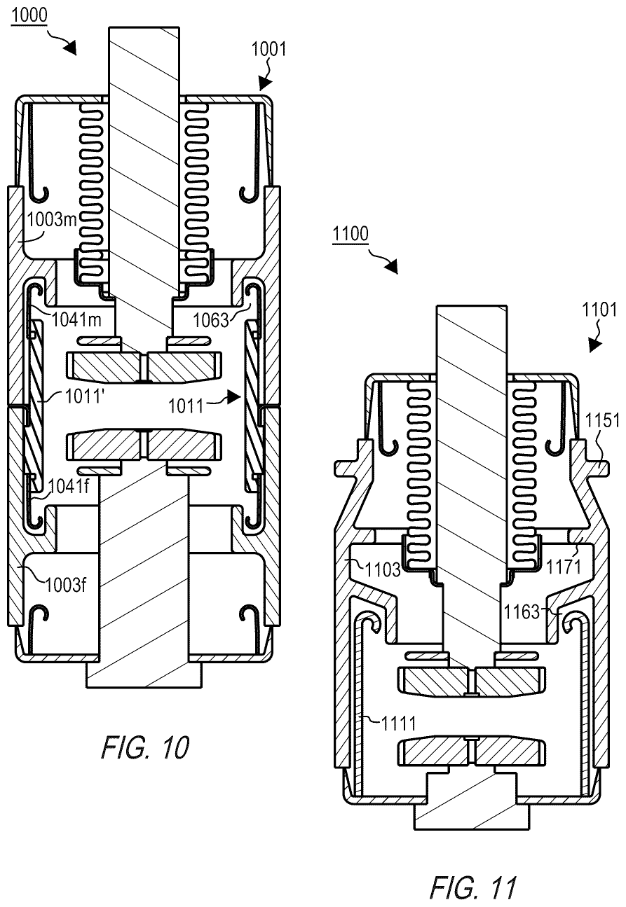

For a medium voltage (MV) vacuum interrupter, the external triple junction on the gas/air side associated with a bellyband or a flange is often left alone, unprotected, as adequate external dielectric is generally not a challenge. (There is generally none or just one of exposed flange or bellyband anyway, for MV. See for example, FIGS. 10 and 11.) For a high voltage (HV) vacuum interrupter, however, it is being learned that protection of an external triple junction is needed, and a number of methods have been developed, to various degrees of success.

There are two more triple junctions for the vacuum interrupter in FIG. 1: the insulator joints to the two end-caps 107 and 109. Internally in the vacuum side end-shields 133 and 135 serve that protection purpose. Externally, the protection is provided by the (proper design of the generally wedge-shape portion of the) conductors, 147 and 149 respectively, that connect the vacuum interrupter to the external busbars (not shown). (Conductor 147 is at the same potential as the movable end 137, and conductor 149 is at the same potential as the fixed end 139.)

When used in a high voltage switchgear, the vacuum interrupter is typically placed inside a container of a dielectric medium surrounding the vacuum interrupter. If this container, commonly and herein referred to as the “tank”, has an insulator portion electrically separating its two metal ends, a circuit breaker of such construction is called a “live-tank” (LT) circuit breaker. If the tank is an all-metal container, and for safety consideration an electrically grounded one, such as 197 shown in FIG. 1, such a switchgear can be a “dead-tank” (DT) circuit breaker, or a gas-insulated-switchgear (GIS). (While FIG. 1 shows one vacuum interrupter within tank 197, there can be more than one vacuum interrupter within a tank. For rated voltages at and below 170 kV, it is typical to have three phases, meaning three vacuum interrupters for a vacuum switching GIS, in a common tank. The three vacuum interrupters can be arranged linearly, or in a triangular pattern.)

With a zero volt tank close by, the floating bellyband 111 (and end-curls 141m, 141f) will pick up a voltage that is significantly lower than half, as low as ⅓ (depending on how close the tank is), of the full test voltage applied across an open contact gap, in between the movable end 137 and the fixed end 139 (henceforth referred to as the “full-test-voltage”).

As employed herein, an electrically floating metal component is defined as being electrically isolated, via one or more of an insulator, from both the movable end and the fixed end of a vacuum interrupter. Examples include a bellyband (e.g. 111 in FIG. 1), or a flange of an internal shield or shield assembly that is sandwiched in between two insulators (e.g. 945 in FIG. 9). For a metallized ceramic insulator, the metallization layer itself is considered and in effect a metal component. By comparison, an electrically fixed metal component, e.g. fixed shield 1111 in FIG. 11, is electrically connected to either one of the movable end or the fixed end of a vacuum interrupter.

If we arbitrary pick the fixed end 139 as the grounded end of zero volt in a dielectric testing setup, then the gaps represented by dimensions D181a and D181b will have to withstand ⅔ of that full-test-voltage, without breakdown. So, bellyband 111 has to be large and tall to have enough clearance away from the side and bottom of coil 125. This means dimension D185 has to be at least that of dimension D187, the distance from the back round of the fixed coil to the back round of the movable coil, in the fully open position.

At the same time, the gap represented by dimension D183, between the high voltage end conductor and the grounded tank, also has to withstand that full-test-voltage. That is why the curved side face of conductor 147 opposite the ID wall of tank 197 is of a large radius. Even so, dimension D183 has to be large enough. But with a straight wall insulator design such as in FIG. 1, dimensions D181 and D183 simply can not be increased at the same time, as they are on the opposite side of the straight wall, without increasing the diameter of the tank.

Also at the same time in the same testing, insulators of 103m and 105m together have to withstand that same ⅔ of full-test-voltage, without flashover. Since the dielectric strength per unit length of a straight wall insulator is limited, a high voltage stress requires a high value for dimension D189. This, combined with a high value in dimension D185 as explained previously, makes the height of the entire vacuum envelope, dimension D191, undesirably large.

As a result, the length of the movable electrode 117 is no longer just dictated by the length of the bellows. A long movable electrode is not good because of its (comparatively) high electrical resistance and low thermal conductance to carry away the heat generated at the mating contacts, thereby negatively impacting the continuous current-carrying capability of the vacuum interrupter. (For HV vacuum interrupters the continuous current-carrying parameter is also technically challenging to meet, because of the high resistance associated with the axial magnetic field generating coils.) Moreover, a long and hence heavy movable electrode is mechanically difficult to drive, to achieve optimum tuning of the travel characteristics of the circuit breaker. As it has come to be understood, for a vacuum interrupter employing an AMF interruption principle, the optimum contact opening travel trajectory should be a fast-slow-fast curve, to balance all the contradictory requirements, esp. between the strength of the axial magnetic field and the dielectric recovery speed in the opening contact gap, in different stages of the high fault current interruption process.

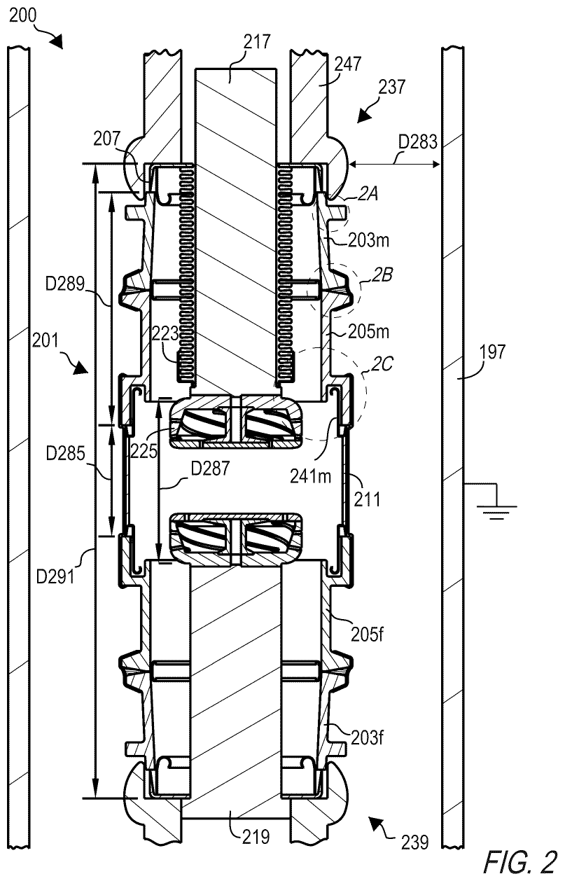

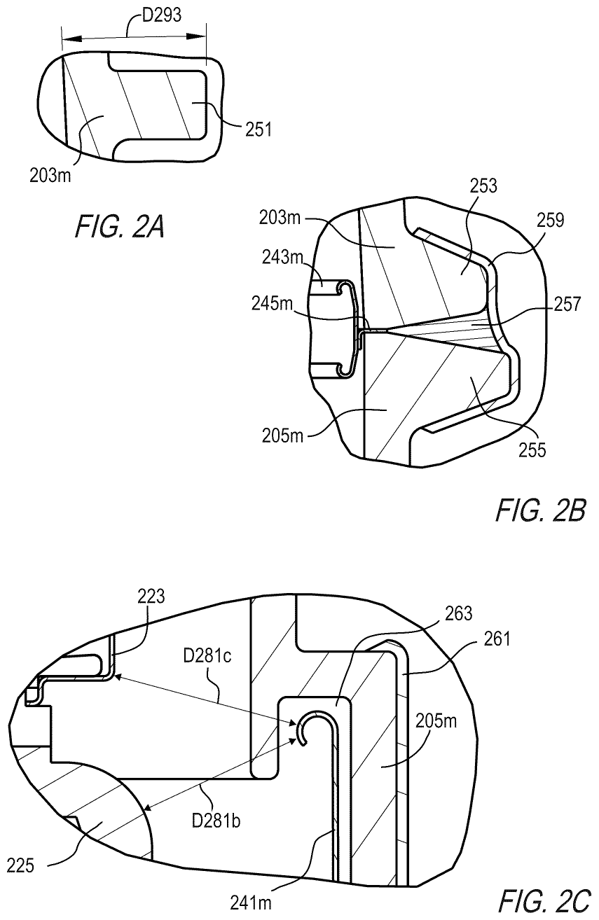

Referring to FIG. 2 now, it shows a vacuum interrupter 200 in accordance with the disclosed concept. The only significant differences from vacuum interrupter 100 in FIG. 1 are the construction of the vacuum envelope 201, and the length of electrodes 217 and 219. Just like vacuum interrupter 100, there are two insulator members on each side of bellyband 211. The first insulator 203m employs a barrier protrusion 251 (see FIG. 2A) near its end close to bus conductor 247. When movable end 237 is the cathode of a voltage between movable end 237 and bellyband 211, such a barrier protrusion increases the resistance to the cascade of electrons coming out of the triple junction associated with the joint between movable seal cup 207 and insulator 203m, or from the high electrical-field tip of the wedge shape portion of conductor 247, down toward bellyband 211. When movable end 237 is the anode, such a barrier, if high (in the radial direction) enough, blocks the line-of-sight between conductor 247 and bellyband 211, to reduce the likelihood of flashover between them. To be effective in increasing the external flashover resistance across an insulator, the height of the barrier, defined as the maximum wall thickness of the insulator in the barrier protrusion portion, D293 (in FIG. 2A), has to be at least 15 mm, for a rated voltage of 66 kV or above.

Near the opposite end of insulator 203m, another OD barrier protrusion 253 (in FIG. 2B) is also provided. Such a barrier, working in conjunction with another OD barrier protrusion 255 provided on insulator 205m, allows the triple junction associated with flange 245m to be very well hidden externally. Additionally, an insulating sealant 257, such as a common conformal coating or a RTV (room temperature volcanizing) silicone, can be applied to the tight space formed by the two butting barrier protrusions 253 and 255, to cover up the exterior surface of flange 245m. And if desired or necessary, another layer of cover, 259, can be provided in the form such as an electrical heat-shrink tubing or an insulating tape. With all of these protective measures, the triple junction associated with flange 245m (and the metallization layers at the end of insulator 203m and 205m, if they are of a metallized ceramic) is prevented, at least drastically inhibited, from becoming a steppingstone of flashover between conductor 247 and bellyband 211.

Insulating member 205m has a larger opening at its end joined to bellyband 211 than at its opposite end joined to flange 245m. This allows insulator 205m to have a portion with an OD similar to that of the straight-wall bellyband 211. Externally, this makes it much easier for the exterior surface of bellyband 211, together with the triple junctions at its two ends, to be covered up with a protective means 261 (see FIG. 2C), such as an electrical heat-shrink tubing or electrical tape or a rubber sleeve or a varnish coating or a molded polyurethane or silicone potting, again for the purpose of reducing the likelihood of flashover to either the movable end 247 or the tank 197. (Parts 259 and 261 are not modelled to scale; they are thickened for better illustration.)

As a result of all the above efforts to boost the external dielectric strength, the overall resistance of the insulator stack (of 203m and 205 m combined) against external flashover can be greatly increased. The necessary insulator height, dimension D289, to pass all the high voltage tests can therefore be smaller than dimension D189 for vacuum interrupter 100. In combination with the new possibility now to have dimension D285 smaller than dimension D287, this small D289 allows electrodes 217 and 219 to be shorter than electrodes 117 and 119 respectively. As explained earlier, this will bring about benefits in high current interruption and continuous current-carrying performances of the vacuum interrupter, and the switchgear employing such a vacuum interrupter.

Internally, a larger opening in insulator 205m at the bellyband end makes it possible for the provision of a longitudinal recess, 263 (in FIG. 2C), where the high electrical-field portion of the tip of end-curl 241m is hidden. By blocking the line-of-sight between this portion of end-curl 241m and the nearby components (coil 225, electrode 217, and bellows shield 223) of the movable end 237, the dielectric withstand capability of the gaps represented by dimension D281b and D281c is significantly improved.

Additionally, the counteracting link between dimensions D281 and D283 is alleviated, to a degree limited by how thick a wall is manufacturable for insulator 203m and 205m (see explanation later with regard to insulators 303 and 304 being frustoconical). As a result D283 is a bit larger than D183, enough to reduce the likelihood of flashover between conductor 247 and tank 197.

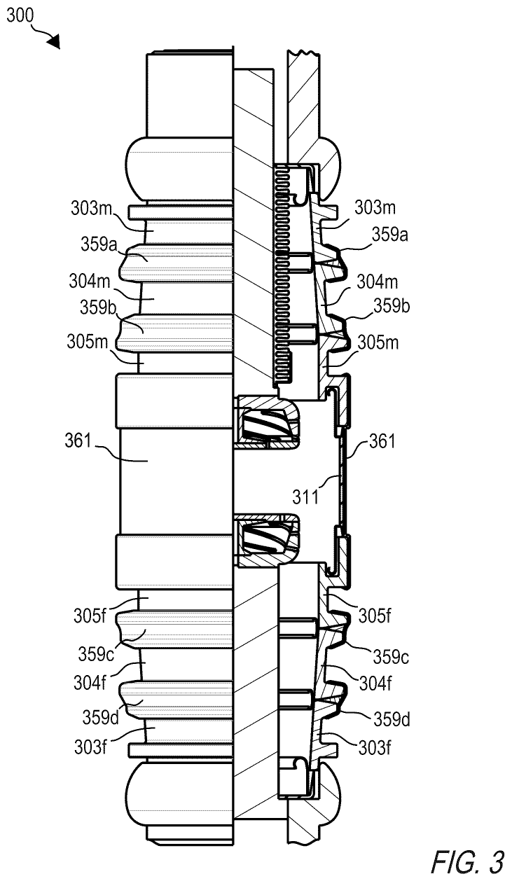

While only two insulating members 203 and 205 are shown on each side of bellyband 211 for vacuum interrupter 200 in FIG. 2, more insulator members can be provided, if necessary, for example to target a high rated voltage of 245 kV or above. As another non-limiting embodiment of the disclosed concept, FIG. 3 shows a vacuum interrupter 300 (together with the bus conductors) that employs three insulators, 303, 304, and 305, on each side of the bellyband 311.

Note that insulators 303 and 304 in FIG. 3 are both of a frustoconical shape of a rather small apex angle, with a slightly larger opening at the end toward the contacts than at the opposite end away from the contacts. This helps reduce the need for a large difference in diameter of the two end openings of insulator 305. The insulator in most commercial vacuum interrupters nowadays is of the metallized alumina type, with its shape machined from a cold-isostatic-pressed (CIP) cylinder of a uniform wall thickness. So there is inherently a limit on how thick a wall is practical for the insulator, particularly for the very large diameter sizes. To design for a very high fault-current interruption rating, which will requires a large contact, and hence a very large diameter for bellyband 311, the number of insulator members may have to be increased even further (from what is dictated by the voltage rating), for this consideration (to enable a large ID increase from the conductor end of the insulator stack to its opposite end joined to the bellyband).

A rated voltage as high as 245 kV will likely need all available means to achieve the required external dielectric strength for the vacuum envelope. For a vacuum envelope involving several insulators stacked together, being able to cover up the multiple triple junctions and the bellyband with electrical heat-shrink sleeves (359a-d and 361 in FIG. 3) will be very advantageous. (Parts 359a-d and 361 are not modelled to scale; they are thickened for better illustration.)

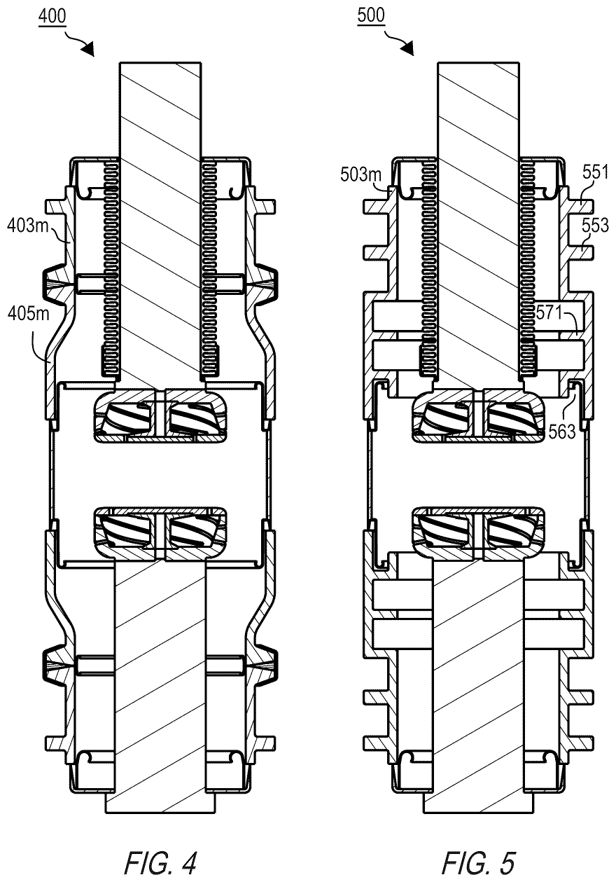

On the other hand, for a not-so-demanding design target, a straight wall tube with a uniform ID may be used, such as insulator 403m for vacuum interrupter 400 shown in FIG. 4, which is another non-limiting embodiment of the disclosed concept. For such a situation, a gradual change of the ID and/or OD may be good enough for the insulator joined to the bellyband, such as shown in insulator 405m, which also forgoes the longitudinal shield hideout recess of 263 shown in FIG. 2C.

Other than the wall thickness, the height or length along the longitudinal direction of the insulator may also have a manufacturability limit. When practical (e.g. for a relatively low rated high voltage such as 145 kV or below), using a single insulator on each side of the bellyband may offer some advantages. FIG. 5 shows one such vacuum interrupter 500, as another non-limiting embodiment of the disclosed concept. A single tall insulator 503m is used, in lieu of the double insulator construction shown in FIGS. 2 and 4. There is no more need for the floating shield 243m and its flange 245 m, nor the associated external triple junction protection means of 257 and 259 (in FIG. 2B). With such a tall/long insulator as insulator 503m, it is relatively easy to machine more than one OD barrier protrusion on the OD wall. (As a non-limiting example, two such protrusions, 551 and 553, are shown for insulator 503m.)

A tall/long thick-wall insulator may also lend itself well to another aspect of the disclosed concept, an internal barrier protrusion, feature 571 shown in FIG. 5, on the ID wall of the insulator. Such an ID barrier protrusion, in conjunction with the shield hideout recess 563, greatly improves the protection of the ID wall of insulator 503m against dielectric degradation associated with deposition of metal vapors originating from arcing activities or breakdown flashes. By providing such an internal barrier protrusion, the useful electric life of the vacuum interrupter in terms of number of load current and fault current interruption operations can be extended. (While only one such internal barrier protrusion is shown for insulator 503m in FIG. 5, more than one can be provided, as long as there is enough length of the insulator to do so practically.)

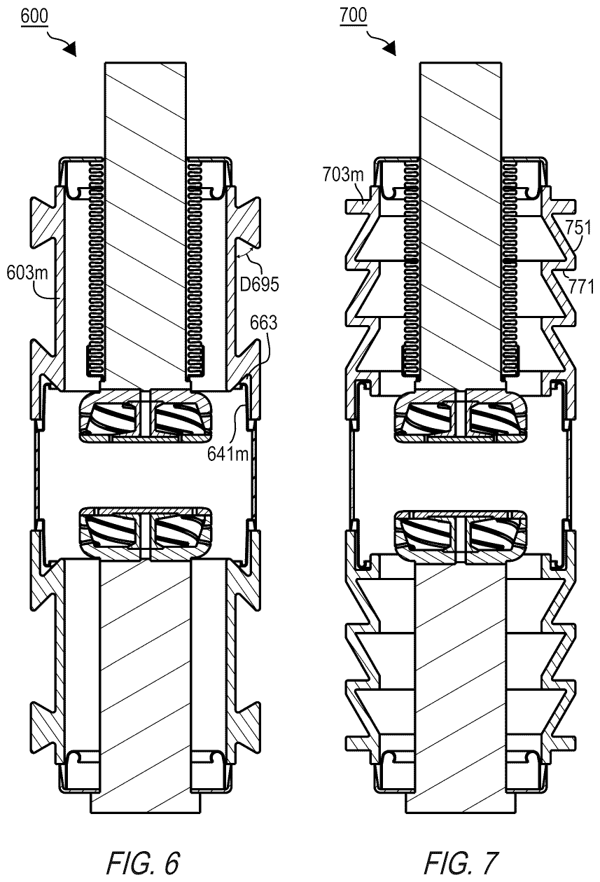

The variation of the OD and/or ID from one end of the insulator to the opposite end (along its longitudinal axis) does not necessarily have to be the stepwise fashion as shown for insulator 503m in FIG. 5, or the gradual change as shown for insulator 405m in FIG. 4. It can be in a sharp zig-zag fashion, with an acute angle (D695) of directional change, such as shown for insulator 603m in vacuum interrupter 600 in FIG. 6, which is another non-limiting embodiment of the disclosed concept. Corresponding to such a sharp ID variation, a triangle is formed as the cross-section shape for the shield hideout recess 663. As long as the high electrical-field tip of the shield part (641m) is well hidden and the lines-of-sight from it to the nearby metal components of the high voltage end are well blocked, any cross-sectional shape of a shield hideout recess is serving its purpose well.

The protrusion, either an OD and/or an ID protrusion, can also have a sharp or step shoulder on only one side (771) and a gradual change of the OD and/or ID on the other side (751) in the longitudinal direction, as exemplified by insulator 703m for vacuum interrupter 700 in FIG. 7, which is another non-limiting embodiment of the disclosed concept. In this way, a step in the wall works as both an ID and an OD barrier.

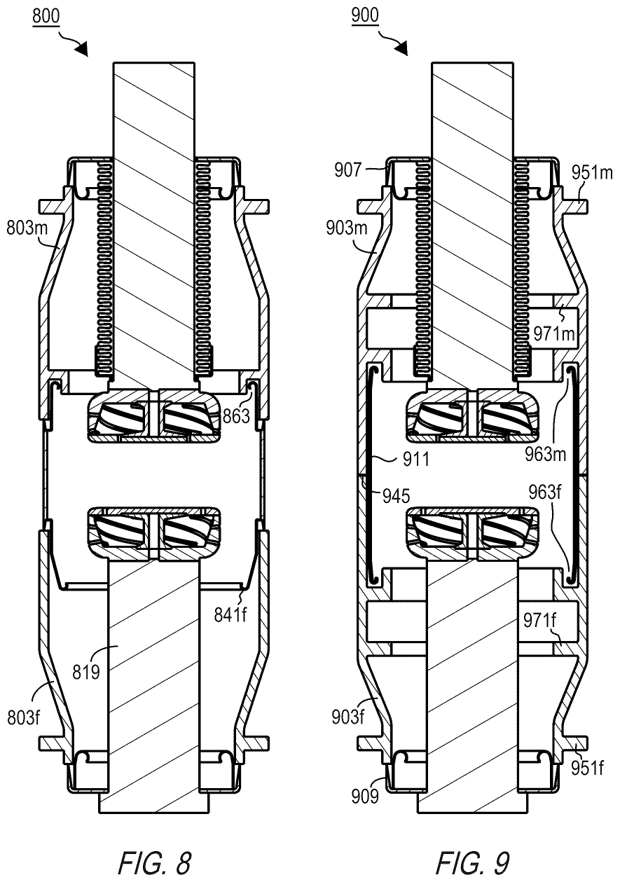

All the vacuum interrupters described so far, 100-700, have a symmetric construction of the insulator portions of the vacuum envelope, employing respectively identical insulators on either side of the floating center shield surrounding the contact gap (a bellyband of external center shield, or an internal center shield such as 911 in FIG. 9 or 1011 in FIG. 10). And for the economy of disclosure, only the movable end insulators have been described in detail so far. It is not only possible but also practiced, however, for the insulator construction to be different between the two sides of the floating center shield. As a non-limiting example, a vacuum interrupter of such, 800, is shown in FIG. 8, which is another embodiment of the disclosed concept. Its movable end insulator 803m has a shield hideout recess (863), while its fixed end insulator 803f does not; there is ample space for fixed end-curl 841f to curl toward fixed electrode 819 to provide good vapor catching and insulator protecting functions, without concern for the electrical-field on its tip being too high to cause breakdown. In addition to the shape of the insulator, the asymmetry can also be in the number of insulators on either side of the floating center shield (or its associated flange).

All the vacuum interrupters described up to this point herein, 100-800, have a floating external center shield, i.e. a bellyband, surrounding the contact gap. However, all the teachings of the disclosed concept also apply to a vacuum interrupter without an external center shield but rather employing an internal center shield. As a non-limiting example, a vacuum interrupter of such, 900, is shown in FIG. 9, which is another embodiment of the disclosed concept. The center shield 911 is completely inside the vacuum envelope, being secured in position via a flange 945 that is sandwiched between two long insulators 903m and 903f. Each of the insulators 903m and 903f employs an OD barrier protrusion 951 (m and f), an ID barrier protrusion 971 (m and f), and a shield hideout recess 963 (m and f) respectively, and each of insulators 903m and 903f has a larger opening at its end joined to the floating center shield flange 945 than at the opposite end joined to the end-cap (907 and 909 respectively.) (While FIG. 9 shows the insulator 903m or 903f each to be a single monolithic piece, either or both of them can be a stack of two or more insulators, if necessary.)

The teaching of making use of the radius or wall thickness dimension of the insulator of a vacuum envelope in general, and the idea to provide OD and ID barriers and a shield hideout in particular, is very much applicable to not only a high voltage vacuum interrupter but also to a medium voltage or a low voltage vacuum interrupter. Vacuum interrupters are increasingly being used for extended duration of time in the open state while sustaining a voltage, especially in the medium or low voltage ranges. In such a situation it is of paramount importance for any momentary breakdown inside the arc chamber to be limited to only between the open contacts; the other components of the arc chamber, especially the stainless-steel components, are not designed to endure a significant number of repeated flashovers. Providing a hideout recess for the high electrical-field portion of a shield component can effectively block its line-of-sight toward nearby metal components at a different electrical potential, thereby reducing the likelihood of flashover. As non-limiting examples, vacuum interrupters 1000 in FIGS. 10 and 1100 in FIG. 11, both being embodiments of the disclosed concept, are shown to employ at least one such shield hideout, 1063 and 1163 respectively. Vacuum interrupter 1000 in FIG. 10 has a double-insulator (1003m and 1003f) envelope 1001 encasing a floating internal center shield assembly 1011. (Note that the non-limiting exemplary shield assembly 1011 uses a thick arc-enduring shield 1011′ and two end-curls 1041m and 1041f.) Such a symmetric vacuum envelope construction is commonly used for a rated voltage of 24 kV or above. More likely seen in 17 kV and below rated voltages, a single ceramic vacuum interrupter 1100 as shown in FIG. 11 employs a single insulator 1103 for its envelope 1101, with the insulator wall protecting shield 1111 electrically fixed to the fixed end of the vacuum interrupter. Note that an OD barrier protrusion 1151 and an ID barrier protrusion 1171 are also provided for insulator 1103. With the help of them, it is possible for vacuum interrupter 1100 to be short and yet capable of a comparatively high external and internal dielectric withstand performance, even with such a compact and low cost fixed shield design. (Both exemplary vacuum interrupters 1000 and 1100 are of the transverse magnetic field, TMF, type, employing a pair of spiral contacts to control the arc for fault current interruption.)

For the ease of illustration and economy of disclosure, only vacuum interrupters of the AMF and the TMF types are shown in the examples of FIGS. 1-11. However, it will be understood that the disclosed concept can be used in any known or suitable combination or alternative arrangement with any known or suitable alternative vacuum switching apparatus therefor, without departing from the scope of the disclosed concept. For example and without limitation, it can be used in a vacuum interrupter with a pair of butt contacts, or a vacuum interrupter of a hybrid of the TMF and AMF interrupting principles, or a vacuum switching apparatus having two movable ends rather than the aforementioned arrangement of a movable end and a fixed end, or a vacuum switching apparatus having more than two contacts such as a 3-position vacuum switch. It can also be used for vacuum earthing switches, vacuum spark-gaps, vacuum fuses, and other vacuum switching devices. Various modifications and alternatives to the specific embodiments could be developed in light of the overall teachings of the disclosed concept which is to be given the full breadth of the claims appended and any and all equivalents thereof.

1. An insulator member of the vacuum envelope of a high voltage vacuum interrupter for a high voltage switching apparatus rated for 66 kV or above, said switching apparatus comprising said vacuum interrupter and a tank enclosing a pressurized dielectric gas surrounding said vacuum interrupter, said vacuum interrupter comprising said vacuum envelope and at least one contact inside said vacuum envelope,
wherein said generally tubular vacuum interrupter has a longitudinal central axis,
wherein said vacuum envelope comprises at least one electrically floating metal member and said insulator member coaxial with said axis,
said metal member having a generally uniform outside diameter (OD) and a height (of its extent along said axis) of at least 20 mm,
said insulator member having a generally tubular shape with a through cavity in its extent along said axis and correspondingly an OD wall and an ID wall,
said insulator member having a first end toward said at least one contact along said axis, and a second end away from said at least one contact and opposite said first end along said axis,
wherein said first end of said insulator member is hermetically sealingly joined to said floating metal member of said vacuum envelope, and
wherein the opening of said through cavity at said first end of said insulator member is larger than the opening of said through cavity at said second end of said insulator member.

2. The insulator member of claim 1, further comprising at least one radial barrier protrusion in a radial direction perpendicular to said axis, either outwardly protruding away from said axis on said OD wall, or inwardly protruding toward said axis on said ID wall.

3. The insulator member of claim 1, wherein the exterior surface of said floating metal member of said vacuum envelope is covered entirely or partially with an electrically protective means such as but not limited to: an electrical heat-shrink tubing, an electrical insulating tape, a rubber sleeve, a varnish coating, or a molded polyurethane or silicone potting.

4. An insulator member of the vacuum envelope of a high voltage vacuum interrupter for a high voltage switching apparatus rated for 66 kV or above, said switching apparatus comprising said vacuum interrupter and a tank enclosing a pressurized dielectric gas surrounding said vacuum interrupter, said vacuum interrupter comprising said vacuum envelope and at least one contact inside said vacuum envelope,
wherein said generally tubular vacuum interrupter has a longitudinal central axis,
wherein said vacuum envelope comprises at least one electrically floating metal member and said insulator member coaxial with said axis,
said insulator member having a through cavity in its extent along said axis, and correspondingly an OD wall, an ID wall, and a wall thickness in a radial direction perpendicular to said axis,
wherein said insulator member comprises at least one radial barrier protrusion in a radial direction perpendicular to said axis, outwardly protruding away from said axis on said OD wall, and
said at least one outwardly protruding radial barrier protrusion having a barrier height, defined as the maximum of said wall thickness of said protrusion portion of said insulator member, of at least 15 mm.

5. The insulator member of claim 4, further comprising at least one radial barrier protrusion in a radial direction perpendicular to said axis and inwardly protruding toward said axis on said ID wall.

6. The insulator member of claim 4, wherein the exterior surface of said floating metal member of said vacuum envelope is covered entirely or partially with an electrically insulative protecting sealant of a material such as but not limited to: silicone, polyurethane, epoxy, and PTFE.

7. The insulator member of claim 6, wherein said sealant is covered entirely or partially by an electrically insulative protecting means such as but not limited to: an electrical heat-shrink tubing, an electrical insulating tape, a rubber sleeve, a varnish coating, or a molded polyurethane or silicone potting.

8. The insulator member of claim 4, wherein the exterior surface of said floating metal member of said vacuum envelope is covered entirely or partially with an electrically insulative protecting means such as but not limited to: an electrical heat-shrink tubing, an electrical insulating tape, a rubber sleeve, a varnish coating, or a molded polyurethane or silicone potting.

9. An insulator member of the vacuum envelope of a vacuum interrupter, said vacuum interrupter comprising said vacuum envelope and at least one contact inside said vacuum envelope,
wherein said generally tubular vacuum interrupter has a longitudinal central axis,
wherein said insulator member has a through cavity in its extent along said axis, and correspondingly an OD wall and an ID wall,
wherein said vacuum interrupter comprises at least one metal shield coaxial and coextensive partially with said insulator member along said axis, said shield having one end at the extreme of its extent along said axis,
wherein said insulator member comprises a longitudinal hideout recess in said ID wall, the entrance of said recess being generally in a plane perpendicular to said axis and facing toward said at least one contact, and the bottom of said recess opposite said entrance of said recess being further away along said axis from said at least one contact, and
wherein said one end of said metal shield is hidden inside said longitudinal hideout recess of said insulator member.

10. The insulator member of claim 9, wherein the opening of said through cavity is larger at one extreme of the extent of said cavity along said axis than at the opposite extreme of the extent of said cavity along said axis.

11. The insulator member of claim 9, further comprising at least one radial barrier protrusion in a radial direction perpendicular to said axis, either outwardly protruding away from said axis on said OD wall, or inwardly protruding toward said axis on said ID wall.

12. The insulator member of claim 9, further comprising at least one radial barrier protrusion in a radial direction perpendicular to said axis and outwardly protruding away from said axis on said OD wall, and at least one radial barrier protrusion in a radial direction perpendicular to said axis and inwardly protruding toward said axis on said ID wall.

13. The insulator member of claim 10, further comprising at least one radial barrier protrusion in a radial direction perpendicular to said axis, either outwardly protruding away from said axis on said OD wall, or inwardly protruding toward said axis on said ID wall.

14. The insulator member of claim 10, further comprising at least one radial barrier protrusion in a radial direction perpendicular to said axis and outwardly protruding away from said axis on said OD wall, and at least one radial barrier protrusion in a radial direction perpendicular to said axis and inwardly protruding toward said axis on said ID wall.

15. A vacuum interrupter comprising an insulator member as set forth in claim 1, and at least one metal member.

16. A vacuum interrupter comprising an insulator member as set forth in claim 4, and at least one metal member.

17. A vacuum interrupter comprising an insulator member as set forth in claim 9, and at least one metal member.

18. A vacuum switching apparatus comprising a vacuum interrupter as set forth in claim 15 and a driving mechanism operatively connected with said vacuum interrupter.

19. A vacuum switching apparatus comprising a vacuum interrupter as set forth in claim 16 and a driving mechanism operatively connected with said vacuum interrupter.

20. A vacuum switching apparatus comprising a vacuum interrupter as set forth in claim 17 and a driving mechanism operatively connected with said vacuum interrupter.
